(19) United States
(12) Patent Application Publication
(10) Pub. No.: US 2012/0285579 A1
(43) Pub. Date: Nov. 15, 2012

(54) FUEL ADDITIVE SYSTEM

(75) Inventors: Newton H. DUDLEY, Blum, TX (US); Richard MILLER, Cleburne, TX (US); John MCDERMOTT, Arlington, TX (US)

(73) Assignee: TECHNICAL CHEMICAL COMPANY, Cleburne, TX (US)

(21) Appl. No.: 13/106,442

(22) Filed: May 12, 2011

(51) Int. Cl. B67D 7/06

(52) U.S. Cl. 141/1; 141/348

(57) ABSTRACT

A fuel additive system can include a fuel additive and a container for the fuel additive, the container including a neck through which the fuel additive is flowed, the neck having a length and a dimension lateral to the length, whereby, in response to insertion of the container into a fuel receptacle, the neck disengages a lock which secures a closure of the fuel receptacle. A method of discharging a fuel additive into a fuel receptacle can include containing the fuel additive in a container having a neck through which the fuel additive can flow, inserting the container into the fuel receptacle, whereby the neck disengages a lock which secures a closure of the fuel receptacle, and discharging the fuel additive from the container into the fuel receptacle via the neck.

### BACKGROUND

This disclosure relates generally to equipment utilized and operations performed in conjunction with fuel systems and, in an example described below, more particularly provides a system for introducing a fuel additive into a fuel system.

It can be beneficial to provide a fuel receptacle with a closure, so that fuel vapors do not escape from a fuel reservoir, and so that debris, water, etc., cannot enter the fuel reservoir. A lock can be used to prevent inadvertent displacement of the closure.

However, the closure will also prevent introduction of a fuel additive (for example, an octane booster, a fuel injector or carburetor cleaner, a lubricant, etc.) into the fuel reservoir. Therefore, it will be appreciated that a need exists for improvements in the art of introducing a fuel additive into a fuel receptacle.

### SUMMARY

In the disclosure below, a fuel additive container is provided which brings improvements to the art of introducing a fuel additive into a fuel receptacle. One example is described below in which the container has a specially configured neck. Another example is described below in which the neck operates a lock to permit displacement of a closure of the fuel receptacle.

In one aspect, a fuel additive system disclosed herein can include a fuel additive, and a container for the fuel additive. The container includes a neck through which the fuel additive is flowed. The neck has a length and a dimension lateral to the length, whereby, in response to insertion of the container into a fuel receptacle, the neck disengages a lock which secures a closure of the fuel receptacle.

In another aspect, a method of discharging a fuel additive into a fuel receptacle is described below. The method can include containing the fuel additive in a container having a neck through which the fuel additive can flow, inserting the container into the fuel receptacle, whereby the neck disengages a lock which secures a closure of the fuel receptacle, and discharging the fuel additive from the container into the fuel receptacle via the neck.

These and other features, advantages and benefits will become apparent to one of ordinary skill in the art upon careful consideration of the detailed description of representative examples below and the accompanying drawings, in which similar elements are indicated in the various figures using the same reference numbers.

### BRIEF DESCRIPTION OF THE DRAWINGS

FIG. 1 is a representative cross-sectional view of a fuel receptacle which can embody principles of the present disclosure.

FIG. 2 is a representative cross-sectional view of the fuel receptacle, taken along line 2-2 of FIG. 1.

FIG. 3 is a representative cross-sectional view of a fuel additive system and associated method, which system and method can embody the principles of this disclosure.

FIG. 4 is a representative cross-sectional view of a container which may be used in the system and method of FIG. 3.

FIG. 5 is a representative enlarged scale detail view of a portion of the FIG. 4 container.

FIG. 6 is a representative elevational view of another configuration of the container.

### DETAILED DESCRIPTION

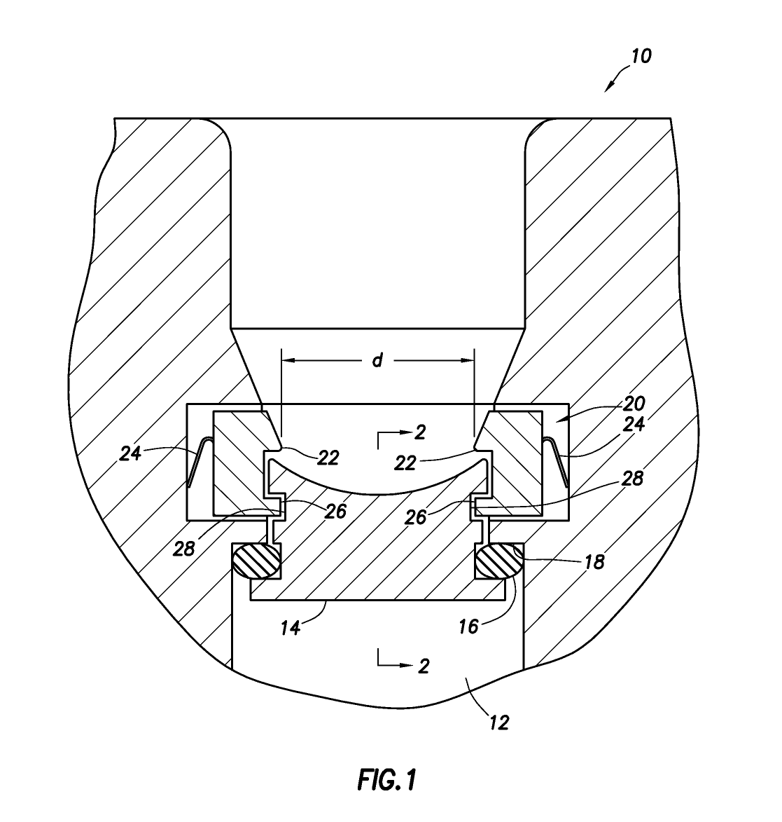

Representatively illustrated in FIG. 1 is a fuel receptacle 10 which can embody principles of this disclosure. In the example depicted in FIG. 1, a fuel entry passage 12 is blocked by a closure 14.

The closure 14 includes a seal 16 which engages a seat 18 to thereby prevent fluid flow through the passage 12. The closure 14 is maintained in its FIG. 1 closed position by means of a lock 20.

The lock 20 in this example includes laterally spaced apart latch members 22. The latch members 22 are biased inward toward each other by springs 24.

The springs 24 maintain engagement between a projection 26 formed on the latch members 22, and a recess 28 formed on the closure 14. As long as the projections 26 are engaged with the recess 28, the closure 14 is prevented from displacing, and the passage 12 remains blocked.

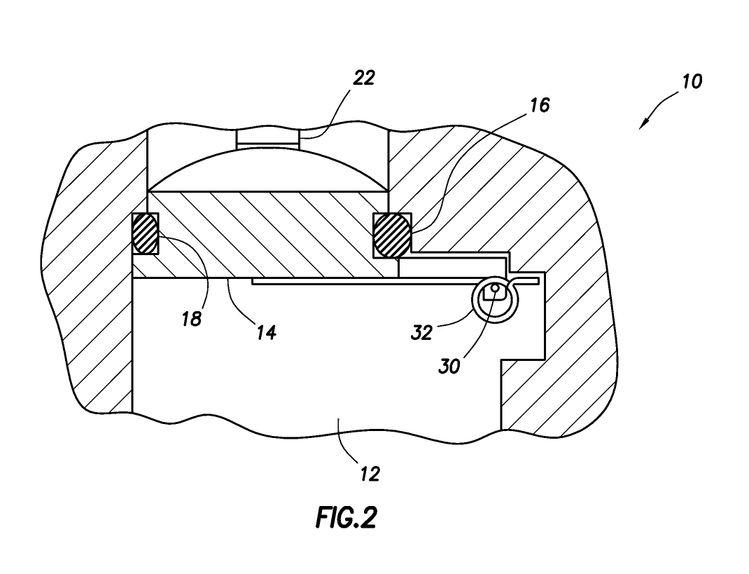

Referring additionally now to FIG. 2, another cross-sectional view of the fuel receptacle 10 is representatively illustrated. In this view, it may be seen that the closure 14 is in the form of a flapper which rotates about a pivot 30.

A torsion spring 32 maintains the closure 14 in its pivoted upward closed position. In this position, the seal 16 remains engaged with the seat 18, preventing flow through the passage 12.

It will be appreciated that, in order to introduce a fuel additive from a container into the fuel receptacle 10, the lock 20 should be disengaged (e.g., spreading apart the latch members 22, so that the projections 26 disengage from the recess 28), and the closure 14 should be displaced to an open position (e.g., whereby flow through the passage 12 is permitted).

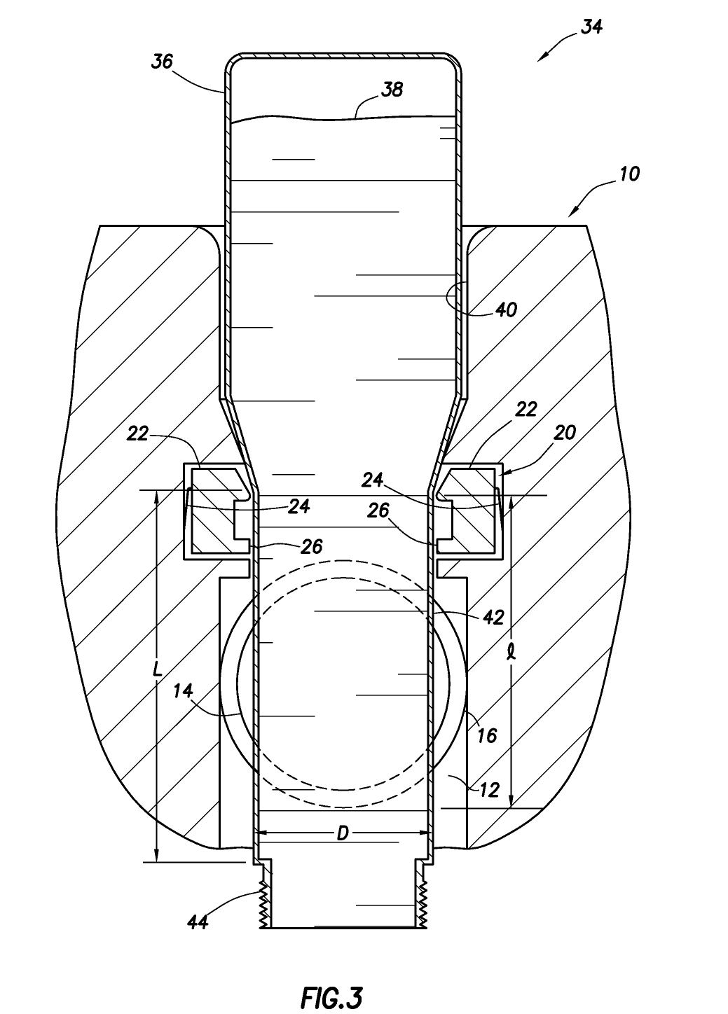

Referring additionally now to FIG. 3, a fuel additive system 34 which can embody principles of this disclosure is representatively illustrated. In this example, the system 34 includes a container 36 having a fuel additive 38 therein.

The fuel additive 38 could be any type of additive or treatment for fuel stored in a reservoir, such as a fuel tank. Fuel additives may include octane boosters, fuel injector cleaners, carburetor cleaners, engine lubricants, etc.

The container 36 is depicted in an inverted position, in which the container is inserted into an opening 40 of the fuel receptacle 10. In this position, the fuel additive 38 can flow out of the container 36 via its neck 42, which extends through the lock 20 and past the closure 14.

The container 36 example depicted in FIG. 3 is in the form of a bottle having a cylindrical neck 42 (circular in lateral cross-section), but it should be understood that other configurations may be used, if desired. For example, the neck 42 is not necessarily circular, it could instead be hexagonal, octagonal, oval, etc.

When the container 36 is inserted into the fuel receptacle 10, the neck 42 overcomes the biasing force exerted by the springs 24 and pushes the latch members 22 apart, thereby releasing the lock 20. Further insertion of the container 36 into the fuel receptacle 10 causes the neck 42 to contact the closure 14, overcome the biasing force exerted by the torsion spring 32, and pivot the closure downward to its open position as depicted in FIG. 3.

The neck 42 preferably has a length L of at least approximately 61.214 mm (˜2.410 in.), for use with the fuel receptacle 10 having a length l from the latch members 22 to the open closure 14, with length L preferably (but not necessarily) being greater than length l.

Of course, different lengths L of the neck 42 may be used in keeping with the principles of this disclosure. However, if the length L is too short, the neck 42 may not effectively disengage the lock 20 and retain the closure 14 in its fully open position.

The neck 42 preferably has a lateral dimension D which is large enough to sufficiently spread apart the latch members 22, and small enough to fit into the passage 12. Preferably, the neck 42 is cylindrical shaped, with a diameter from approximately 21.488 mm (˜0.846 in.) to approximately 21.640 mm (˜0.852 in.), for use with latch members 22 initially spaced apart by a lateral dimension d (see FIG. 1) of approximately 19.685 mm (˜0.775 in.).

Of course, different lateral dimensions D of the neck 42 may be used in keeping with the principles of this disclosure. However, if the lateral dimension D is too small, the neck 42 may not effectively disengage the lock 20 by spreading apart the latch members 22. If the lateral dimension D is too large, the neck 42 may not fit into the entry passage 12.

The neck 42 may be provided with threads 44 for attaching a cap to close off the neck. If the threads 44 have a large enough diameter, their length could be included in the length L.

Threads 44 preferably have a flat crest 46 at their major diameter. The flat crest 46 prevents the threads 44 from catching on the latch members 22, closure 14 and various shoulders, etc. in the fuel receptacle 10 as the neck 42 is inserted and removed from the fuel receptacle.

Although in the example depicted in FIGS. 1-3, the container 36 is inverted to flow the fuel additive 38 into the passage 12, in other examples, the additive could be flowed into the passage 12 without inverting the container. For example, the container 36 and fuel receptacle 10 could be inclined at any point between horizontal and vertical orientations, etc.

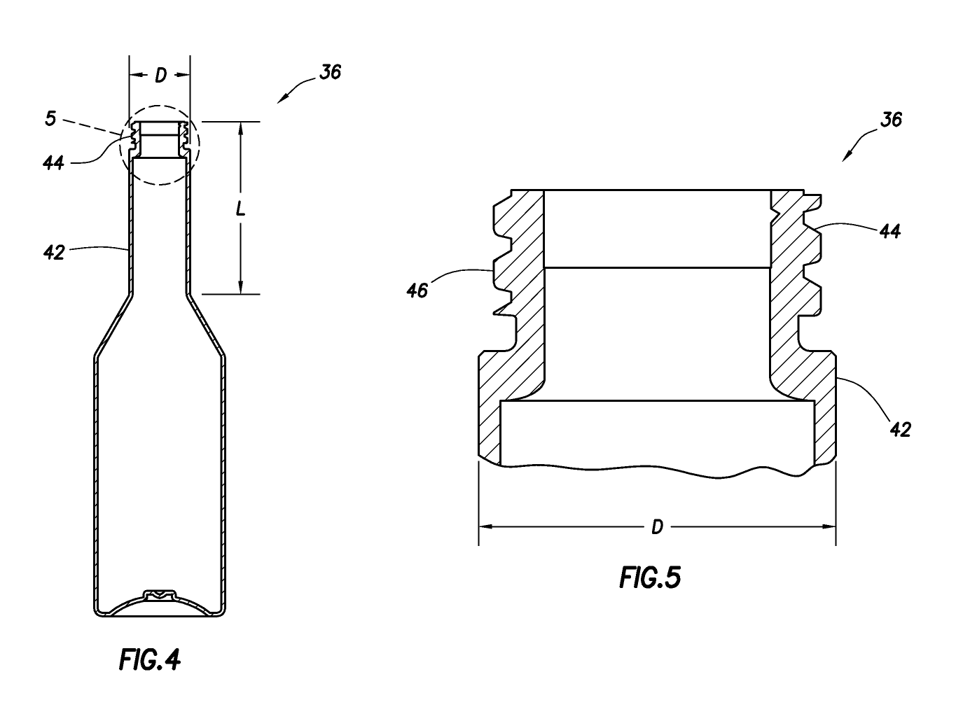

Referring additionally now to FIG. 4, a cross-sectional view of one configuration of the container 36 is representatively illustrated. In this view, it may be seen that the length L of the neck 42 includes the length of the threads 44, since the threads are of appropriate dimensions to spread apart the latch members 22 and maintain the closure 14 in its open position.

In this example, the length L of the neck 42 is preferably about 61.341 mm (˜2.415 in.), and the lateral dimension D is preferably about 21.488 mm (˜0.846 in.). Of course, other dimensions may be used and still remain within the scope of this disclosure.

Referring additionally now to FIG. 5, an enlarged scale cross-sectional view of the threads 44 is representatively illustrated. In this view, it may be seen that the threads 44 have a flat crest 46, that is, the threads have a generally cylindrical major diameter surface. The flat crest 46 provides for convenient and effective insertion of the neck 42 into the receptacle 10, and subsequent removal of the neck from the receptacle.

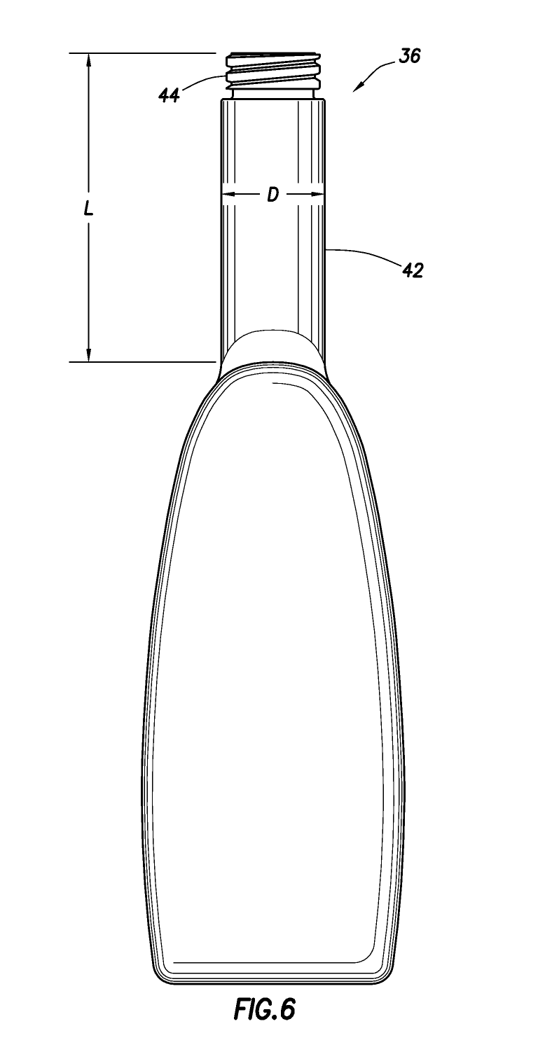

Referring additionally now to FIG. 6, another configuration of the container 36 is representatively illustrated. In this configuration, the neck length L again includes the length of the threads 44.

In this example, the length L of the neck 42 is preferably about 64.44 mm (˜2.537 in.), and the lateral dimension D is preferably about 21.49 mm (˜0.846 in.). Of course, other dimensions may be used and still remain within the scope of this disclosure.

It may now be fully appreciated that this disclosure provides several advancements to the art of introducing a fuel additive into a fuel receptacle. Using the system 34 described above, the fuel additive 38 can be conveniently introduced into the fuel receptacle 10 by inserting the container 36 into the opening 40, with the neck 42 of the container disengaging the lock 20 and displacing the closure 14. The fuel additive 38 can flow from the container 36 into the passage 12 via the neck 42, with the neck maintaining the closure 14 in its open position.

The above disclosure provides to the art a fuel additive system 34 which can include a fuel additive 38 and a container 36 for the fuel additive 38. The container 36 includes a neck 42 through which the fuel additive 38 is flowed. The neck 42 has a length L and a dimension D lateral to the length L, whereby, in response to insertion of the container 36 into a fuel receptacle 10, the neck 42 disengages a lock 20 which secures a closure 14 of the fuel receptacle 10.

The neck 42 may pivot the closure 14 in response to insertion of the container 36 into the receptacle 10.

The container 36 may comprise a bottle.

The system 34 can include threads 44 on the neck 42. The threads 44 may have a flat crest 46.

Insertion of the container 36 into the receptacle 10 can cause displacement of the closure 14. Displacement of the closure 14 may permit fluid flow into the receptacle 10.

The neck 42 length L may be at least approximately 61.214 mm.

The dimension D lateral to the length L of the neck 42 may be at least approximately 21.488 mm, or from approximately 21.386 mm to approximately 21.640 mm.

Also described above is a method of discharging a fuel additive 38 into a fuel receptacle 10. The method can include containing the fuel additive 38 in a container 36 having a neck 42 through which the fuel additive 38 can flow; inserting the container 36 into the fuel receptacle 10, whereby the neck 42 disengages a lock 20 which secures a closure 14 of the fuel receptacle 10; and discharging the fuel additive 38 from the container 36 into the fuel receptacle 10 via the neck 42.

The method may include the step of engaging the closure 14 with the neck 42, thereby displacing the closure 14. The closure 14 may comprise a flapper which pivots to an open position when the neck 42 engages the flapper.

Fluid flow into the fuel receptacle 10 is permitted after the step of inserting the container 36 into the fuel receptacle 10. Fluid flow into the fuel receptacle 10 is prevented by the closure 14 prior to the step of inserting the container 36 into the fuel receptacle 10.

The lock 20 may comprise spaced apart latch members 22. A lateral dimension d between the latch members 22 is preferably less than a lateral dimension D of the neck 42. Inserting the container 36 into the receptacle 10 may include the neck 42 further spacing apart the latch members 22.

The neck 42 may extend through the lock 20 and past the closure 14 after inserting the container 36 into the fuel receptacle 10.

It is to be understood that the various examples described above may be utilized in various orientations, such as inclined, inverted, horizontal, vertical, etc., and in various configurations, without departing from the principles of the present disclosure. The embodiments illustrated in the drawings are depicted and described merely as examples of useful applications of the principles of the disclosure, which are not limited to any specific details of these embodiments.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A fuel additive system, comprising:
a fuel additive; and
a container for the fuel additive, the container including a neck through which the fuel additive is flowed, the neck having a length and a dimension lateral to the length, whereby, in response to insertion of the container into a fuel receptacle, the neck disengages a lock which secures a closure of the fuel receptacle.

2. The system of claim 1, wherein the neck pivots the closure in response to insertion of the container into the receptacle.

3. The system of claim 1, wherein the container comprises a bottle.

4. The system of claim 1, further comprising threads on the neck.

5. The system of claim 4, wherein the threads have a flat crest.

6. The system of claim 1, wherein insertion of the container into the receptacle causes displacement of the closure.

7. The system of claim 6, wherein displacement of the closure permits fluid flow into the receptacle.

8. The system of claim 1, wherein the neck length is at least approximately 21.488 mm.

9. The system of claim 1, wherein the dimension lateral to the length of the neck is at least approximately 21.488 mm.

10. The system of claim 1, wherein the dimension lateral to the length of the neck is from approximately 21.386 mm to approximately 21.640 mm.

11. A method of discharging a fuel additive into a fuel receptacle, the method comprising:
containing the fuel additive in a container having a neck through which the fuel additive can flow;
inserting the container into the fuel receptacle, whereby the neck disengages a lock which secures a closure of the fuel receptacle; and
discharging the fuel additive from the container into the fuel receptacle via the neck.

12. The method of claim 11, further comprising the step of engaging the closure with the neck, thereby displacing the closure.

13. The method of claim 12, wherein the closure comprises a flapper which pivots to an open position when the neck engages the flapper.

14. The method of claim 11, wherein fluid flow into the fuel receptacle is permitted after the step of inserting the container into the fuel receptacle.

15. The method of claim 14, wherein fluid flow into the fuel receptacle is prevented by the closure prior to the step of inserting the container into the fuel receptacle.

16. The method of claim 11, wherein the neck has a length of at least approximately 21.488 mm.

17. The method of claim 16, wherein the neck has a dimension lateral to the length of at least approximately 21.488 mm.

18. The method of claim 16, wherein the neck has a dimension lateral to the length from approximately 21.386 mm to approximately 21.640 mm.

19. The method of claim 11, wherein the lock comprises spaced apart latch members, and wherein a lateral dimension between the latch members is less than a lateral dimension of the neck.

20. The method of claim 11, wherein the lock comprises spaced apart latch members, and wherein inserting the container into the receptacle further comprises the neck further spacing apart the latch members.

21. The method of claim 11, wherein the neck extends through the lock and past the closure after the step of inserting the container into the fuel receptacle.
